(19) United States
(12) Patent Application Publication
(10) Pub. No.: US 2019/0082883 A1
(43) Pub. Date: Mar. 21, 2019

(54) SPIT ROD ASSEMBLY AND ACCESSORY THEREFOR

(71) Applicant: Shriro Australia Pty Limited, Kingsgrove (AU)

(72) Inventors: David Jones, Beecroft (AU); David Mansueto, Rose Bay (AU); Anson Li, Balmain (AU)

(21) Appl. No.: 16/130,229

(22) Filed: Sep. 13, 2018

(30) Foreign Application Priority Data
Sep. 21, 2017 (AU) 2017232153

(51) Int. Cl. A47J 37/04; A47J 37/07

(52) U.S. Cl. CPC A47J 37/041; A47J 37/0704

(57) ABSTRACT

The present invention provides an accessory for a spit rod assembly, with the accessory being configured to be mounted on a spit rod. The accessory comprises at least one mounting hub having a channel for receiving the spit rod there-through, such that the accessory is movable along a length of the spit rod by moving or sliding the accessory relative to the spit rod. The mounting hub includes a locking mechanism for fixing the accessory at a selected position along the length of the spit rod. The locking mechanism comprises an actuator member for manual application of a clamping force to the spit rod, and a resiliently biased reaction member located on a side of the spit rod opposite the actuator member for applying or exerting a reaction force or counter-force on the spit rod. The accessory may be a fork accessory. The accessory may also be a basket accessory.

### RELATED APPLICATION

This application claims priority under 35 U.S.C. 119(b) to Australian Patent Application No. 2017232153, which was filed on Sep. 21, 2017, and the disclosure of which is hereby incorporated by reference.

### FIELD OF THE INVENTION

The present invention relates to a spit rod assembly for a cooker, such as a barbecue, grill, or oven, and to an accessory configured for such a spit rod assembly.

In this regard, it will be appreciated that the invention has particular application to outdoor cookers, such as barbecues, and it will be convenient to describe the invention in this exemplary context.

### BACKGROUND OF THE INVENTION

Barbecues that have spit functionality have been gaining in popularity in recent years and the present applicant has been pursuing the development of new products to meet the increasing consumer demand in this field. An example of this kind of development is shown in the international patent application published as WO 2017/063019 A1. In this context, the present inventors have developed various improvements in a spit rod assembly and accessories for a spit rod assembly for use with such barbecues.

### SUMMARY OF THE INVENTION

In view of the above, it is an object of the present invention to provide a new and improved spit rod assembly and accessories therefor for use with barbecues having spit functionality.

According to one aspect, therefore, the present invention provides a spit rod assembly for use in a cooker, such as a grill or barbecue, comprising: an elongate spit rod, and an accessory configured to be mounted on the spit rod. The accessory comprises at least one mounting hub having a channel for receiving the spit rod therein, such that the accessory is movable along a length of the spit rod by moving or sliding the accessory via the mounting hub relative to the spit rod, and a locking mechanism for fixing the accessory at a selected position along the length of the spit rod. The locking mechanism is typically provided on the mounting hub and comprises an actuator member for manual application of a clamping force to the spit rod, and a resiliently biased reaction member or counter-member located on a side of the spit rod opposite the actuator member for applying a reaction force or counter-force to the spit rod.

In this way, the present invention provides a spit rod assembly with which an accessory on the spit rod can be quickly and easily positioned and/or moved. The locking mechanism provides for the quick, easy and highly reliable fixture and release of the accessory without the application of high manual forces by a user. The reaction member or counter-member bears against the spit rod opposite the actuator member and is movable under the resilient bias as the clamping force is applied.

In a preferred embodiment, the actuator member is movable between a first released position for moving the accessory along the spit rod and a second locked position for fixing the accessory relative to the spit rod, and wherein the reaction member or counter-member is movable in a direction transverse to a longitudinal extent of the spit rod under the resilient bias. The actuator member preferably comprises a lever configured for pivoting movement between the first released position and the second locked position; the pivoting movement preferably being through an angle in the range of about 30 degrees to about 90 degrees. In this regard, the actuator member may include a handle portion configured to be grasped and manually actuated by a user at one end region of the lever, and a nose portion for engaging and applying clamping force to the spit rod at an opposite end region of the lever. The nose portion preferably includes a curved or rounded surface for increasingly bearing upon a surface of the spit rod as the lever is pivoted from the released position to the locked position. The actuator member will therefore typically include a pivot pin upon which the lever is pivotally mounted in the hub as the fulcrum for the pivoting movement. In this way, as the actuator lever is moved or pivoted from the released position to the locked position to increasingly apply the clamping force to the spit rod held within the channel, the movable reaction member on the opposite side of the spit rod from the actuator member can move or deflect under its resilient bias for a gradual clamping of the spit rod between the nose portion of the lever and the reaction member.

In a preferred embodiment, the reaction member is accommodated within a recess which is provided in the mounting hub and communicates with the channel for receiving the elongate spit rod. The reaction member is configured for movement under resilient bias in a direction transverse to a longitudinal axis of the spit rod. The reaction member is accommodated within the recess preferably in a substantially form-fitting manner, such that sides or walls of the recess support and guide movement of the reaction member. The reaction member itself preferably comprises a body presenting a contact surface for contacting a side of the spit rod opposite the actuator member. In this regard, the reaction member is preferably movable in a direction transverse to the longitudinal axis of the spit rod between a substantially fully recessed position and a maximal extended position.

In a preferred embodiment, the reaction member is mounted in the recess in the hub for movement in the direction transverse to the longitudinal axis of the spit rod via a pin. In this regard, the reaction member may comprise a slot for receiving the pin, and ends of the slot may thus define limits of movement for the reaction member between the maximal recessed position and the maximal extended position. The reaction member is preferably resiliently biased by at least one spring element, such as a spring washer (e.g. Belleville washer), which may be provided in the recess for accommodating the reaction member.

In a preferred embodiment, the accessory is a fork accessory comprising two or more tines or prongs extending from the mounting hub in a direction generally parallel to the spit rod for fastening a portion of food, especially meat, to the spit rod.

In a preferred embodiment, the accessory is a basket accessory comprising a basket enclosing a cavity for receiving food items therein, wherein the basket accessory comprises two mounting hubs for mounting the basket on the spit rod, each of the mounting hubs being provided at a respective end of the basket.

In a preferred embodiment, the spit rod assembly further comprises an adapter member for adapting the channel through the mounting hub to a different sized spit rod. In particular, the adapter member is configured to reduce the cross-sectional area of the channel through the hub to make it suitable for mounting the accessory on a smaller diameter spit rod.

According to another aspect, the present invention provides an accessory for a spit rod. The accessory is configured to be mounted on the spit rod and comprises: at least one mounting hub having a channel for receiving the spit rod there-through, such that the accessory is movable along a length of the spit rod by moving or sliding the accessory relative to the spit rod. The mounting hub includes a locking mechanism for fixing the accessory at a selected position along the length of the spit rod. The locking mechanism comprises an actuator member for manual application of a clamping force to the spit rod, and a resiliently biased reaction member located on a side of the spit rod opposite the actuator member for applying a reaction force or counter-force to the spit rod.

In a preferred embodiment, the accessory is a fork accessory and comprises two or more tines or prongs which extend from the mounting hub for fastening a portion of food, especially meat, to the spit rod.

Thus, according in a preferred embodiment, the invention provides a fork accessory for a spit rod assembly. The fork accessory is configured to be mounted on a spit rod and comprises: at least one mounting hub having a channel for receiving the spit rod there-through, whereby the fork accessory is movable along a length of the spit rod by moving or sliding the fork accessory relative to the spit rod; and two or more tines or prongs which extend from the mounting hub in a direction generally parallel to an axis of the channel (i.e. to the spit rod) for fastening a portion of food, especially meat, to the spit rod. The mounting hub includes a locking mechanism for fixing the fork accessory at a selected position along the length of the spit rod. The locking mechanism comprises an actuator member for manual application of a clamping force to the spit rod, and a movable reaction member, which is preferably resiliently biased, located on a side of the spit rod opposite the actuator member for exerting a reaction force or counter-force on the spit rod when the clamping force is applied via the actuator member.

In a preferred embodiment, the accessory is a basket accessory comprising a basket that encloses a cavity for receiving food items therein. In this embodiment, two mounting hubs are preferably provided for mounting the basket on the spit rod, with one of the two mounting hubs being arranged at a respective end of the basket.

Thus, according in a preferred embodiment, the invention provides a basket accessory for a spit rod assembly. The basket accessory is configured to be mounted on a spit rod and comprises: a basket enclosing a space or cavity for receiving food items therein, and two mounting hubs for mounting the basket on the spit rod, each of the mounting hubs provided at a respective end of the basket and having a channel for receiving the spit rod there-through, such that the basket accessory is movable along a length of the spit rod by moving or sliding the basket accessory relative to the spit rod. Each mounting hub includes a locking mechanism for fixing the basket accessory at a selected position along the length of the spit rod. The locking mechanism comprises an actuator member for manual application of a clamping force to the spit rod, and a movable, resiliently biased reaction member located on a side of the spit rod opposite the actuator member for exerting or applying a reaction force or counter-force to the spit rod.

In a preferred embodiment, the actuator member is movable between a first released position at which the accessory is movable along the spit rod and a second locked position for clamping and fixing the accessory relative to the spit rod, and the reaction member is movable under its resilient bias in a direction transverse to a longitudinal axis of the spit rod.

In a preferred embodiment, the actuator member comprises a lever configured for pivoting movement between the first released position and the second locked position; the pivoting movement preferably being through an angle in the range of about 30 degrees to about 90 degrees. To this end, the actuator member may have a handle portion configured to be grasped and manually actuated by a user at one end region of the lever, and a nose portion for engaging and applying clamping force to the spit rod at an opposite end region of the lever. The actuator member includes a pivot pin upon which the lever is pivotally mounted in the mounting hub.

In a preferred embodiment, the reaction member is accommodated within a recess in the mounting hub for movement under resilient bias in a direction transverse to a longitudinal axis of the spit rod. The reaction member is preferably movable in the direction transverse to the longitudinal axis of the spit rod between a maximal recessed position and a maximal extended position. In this regard, the reaction member may be mounted in the recess via a pin for movement in the direction transverse to the longitudinal axis of the spit rod. The reaction member may include a slot for receiving the pin, whereby ends of the slot define limits of movement for the reaction member; e.g. between the maximal recessed position and the maximal extended position. Preferably, the reaction member is resiliently biased by at least one spring element, such as a spring washer (e.g. Belleville washer), which may be provided in the recess for accommodating the reaction member.

### BRIEF DESCRIPTION OF THE DRAWINGS

For a more complete understanding of the invention and the advantages thereof, exemplary embodiments of the invention are explained in more detail in the following description with reference to the accompanying drawing figures, in which like reference signs designate like parts and in which:

FIG. 1 is a perspective view of a spit rod assembly according to a preferred embodiment of the invention;

FIG. 2 is a perspective view of a fork accessory according to a preferred embodiment for the spit rod assembly shown in FIG. 1;

FIG. 3 is an exploded perspective view of the fork accessory shown in FIG. 2;

FIG. 4 is a perspective view of a basket accessory according to a preferred embodiment for a spit rod assembly according to an embodiment of the invention;

FIG. 5 is a perspective view of a basket accessory according to another preferred embodiment for a spit rod assembly according to another embodiment;

FIG. 6 is a perspective view of the basket accessory shown in FIG. 5 in an open state;

FIG. 7 is a perspective view of a spit rod assembly according to another preferred embodiment of the invention incorporating the basket accessory of FIG. 5;

FIG. 8 is a perspective view of an end of a basket accessory according to a preferred embodiment;

FIG. 9 is a perspective view of an adapter member for use in the mounting hub of the basket accessory of FIG. 8;

FIG. 10 is a perspective view of two adapter members for use in the mounting hub of the basket accessory of FIG. 8;

FIGS. 11 (a) to (e) are perspective views illustrating the installation and operation of adapter members of FIGS. 9 and 10 in the basket accessory of FIG. 8.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will also be understood that certain actions and/or steps in an embodiment of a method may be described or depicted in a particular order of occurrences while those skilled in the art will understand that such specificity with respect to sequence is not actually required.

### DETAILED DESCRIPTION OF EMBODIMENTS

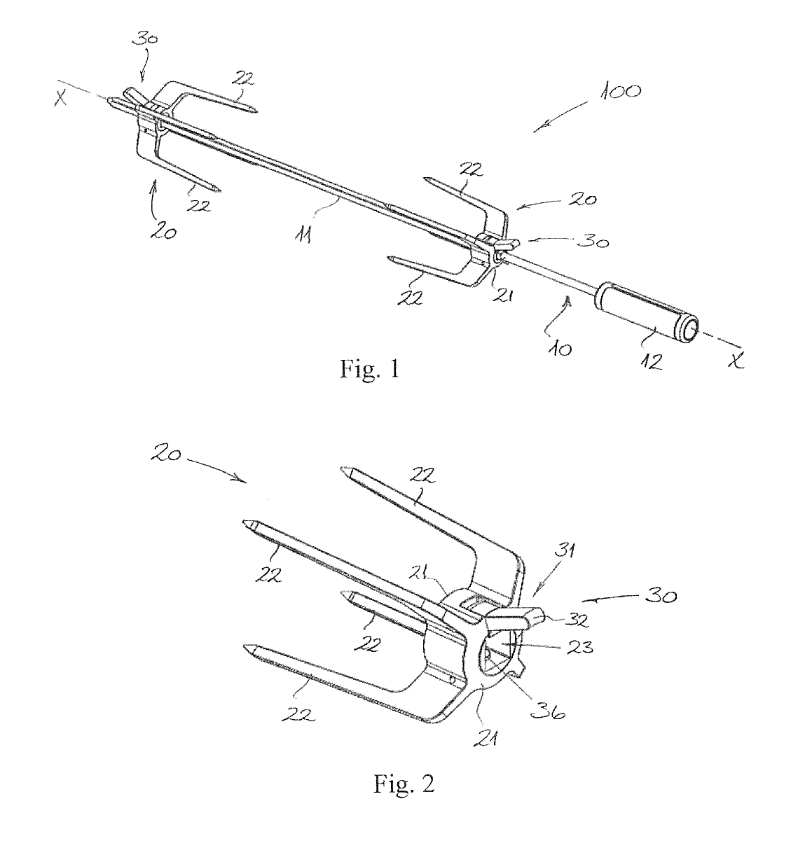

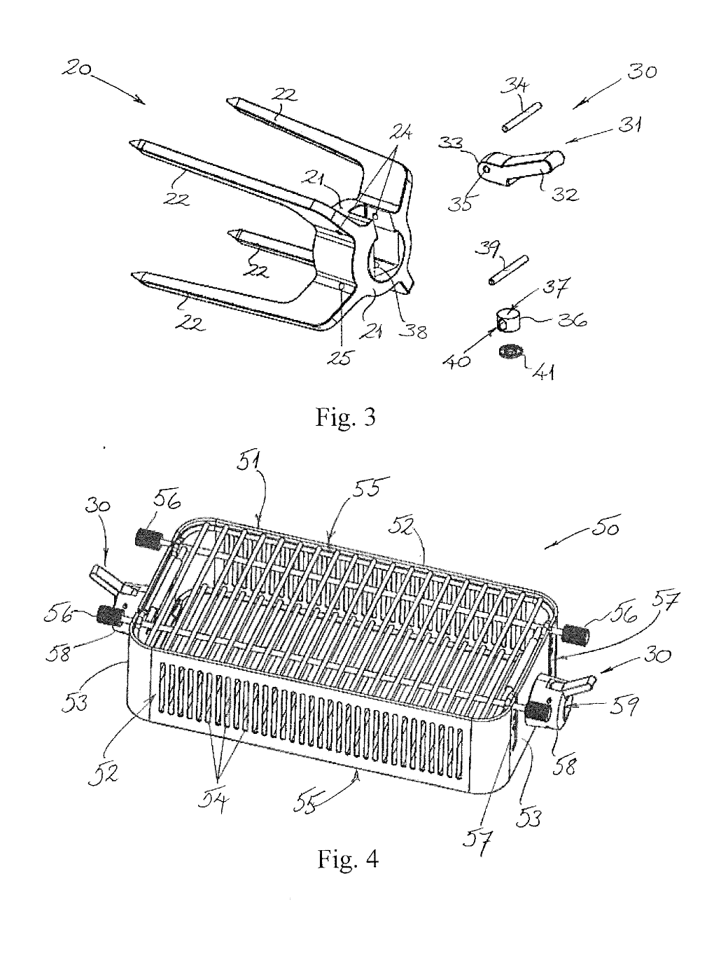

Referring firstly to FIGS. 1 to 3 of the drawings, a spit rod assembly 100 comprising a spit rod 10 and two fork accessories 20 is shown in FIG. 1, with the details of each of the fork accessories 20 then shown in more detail in FIGS. 2 and 3.

The spit rod 10 itself comprises an elongate rod 11 having a longitudinal axis X and a generally square cross-section transverse to the longitudinal axis. The spit rod 10 also includes a handle 12 fixed at one end region of the elongate rod 11 for a user to hold and manipulate the spit rod assembly 100 in use. It will be noted that the handle 12 may be retractable or movable (e.g., telescopically) axially along the rod 11 to reduce an overall length of the spit rod 10. This is a particularly practical feature when the spit rod 10 is not in use, as a reduction in the overall length of the spit rod 10 makes storage simpler; for example in a cupboard or a drawer.

Each fork accessory 20 comprises a central hub 21 for mounting the fork accessory 20 on the spit rod 10, and four prongs or tines 22 for fastening a portion of food, especially meat, to the spit rod 10 which extend from the hub 21. When the fork accessory 20 is mounted on the spit rod 10 as shown in FIG. 1, the prongs or tines 22 extend in a direction that is generally or approximately parallel to the axis of the rod 11. The mounting hub 21 of the fork accessory 20 includes a channel 23 which is sized and shaped for receiving the elongate rod 11 therein, such that the fork accessory 20 is movable or slidable along the length of the spit rod 10 via the mounting hub 21. As will be apparent from drawing FIGS. 2 and 3, the mounting hub 21 also includes a locking mechanism 30 for fixing the fork accessory 20 at a selected position along the length of the spit rod 10.

The locking mechanism 30 is provided in or on the mounting hub 21 and includes an actuator member 31 for manual application of a clamping force to the spit rod 10. In particular, the actuator member 31 comprises a lever having a gripping portion or handle portion 32 which is configured to be grasped and manually actuated by a user at one end region of the lever, and a nose portion 33 for engaging and applying clamping force to the spit rod 10 at an opposite end region of the lever. This lever-type actuator member 31 is mounted to the hub 21 via a pin 34, which is mounted in holes or bores 24 provided in the hub 21 and received in a corresponding bore 35 through the lever and forms a pivot or fulcrum for pivoting movement. Thus, the lever-type actuator member 31 is configured to pivot about the pin 34 through an angle of about 60 degrees between a first released position (not shown, but where the handle portion 32 would extend approximately vertically in FIG. 2), in which a position of the fork accessory 20 is freely movable along the spit rod 10, and a second locked position (shown in FIG. 2), for fixing the position of the fork accessory 20 relative to the spit rod 10. In this way, a curved or rounded end surface of the nose portion 33 of the actuator lever 31 would be moved or pivoted to bear increasingly against an adjacent flat face of the spit rod 11 accommodated in the channel 23 as the actuator member 31 is pivoted from the released position to the locked position.

The locking mechanism 30 further includes a resiliently biased reaction member 36 in the mounting hub 21 located on a side of the elongate rod 11 opposite the actuator member 31 for exerting a reaction force or counter-force on the rod 11 as a clamping force is applied by the actuator member 31. The reaction member 36 in this embodiment comprises a generally cylindrical body presenting a contact surface 37 for contacting a flat face of the square cross-sectioned spit rod 11 opposite the actuator member 31. The cylindrical shaped reaction member 36 sits within a recess 38 in the mounting hub 21. The recess 38 is provided such that it communicates with the channel 23 which receives the elongate spit rod 11. The reaction member is configured for movement in the recess under resilient bias in a direction transverse to a longitudinal axis X of the spit rod 10. Because the recess 38 is a circular bore matched to the dimensions of the body of the reaction member 36, the sides or walls of the recess 38 are configured to support and guide movement of the reaction member 36. In this regard, the reaction member 36 is mounted in the recess 38 in the hub 21 for movement in the direction transverse to the longitudinal axis X of the spit rod 10 via a pin 39, ends of which are fixed in the holes or bores 25 in the hub 21. The reaction member includes a slot 40 for receiving the pin 39, and ends of the slot 40 thus define limits to the movement of the reaction member 36 between a maximal recessed position in the recess 38 and a maximal extended position projecting into the channel 23. The reaction member 36 is resiliently biased by at least one spring washer 41 (e.g. a Belleville washer), which is set in the bore or recess 38 below the reaction member 36. In this way, the reaction member 36 is movable transverse to the spit rod under a resilient bias.

As will be appreciated, the reaction member 36 is pressed under the resilient bias of the spring washer 41 into the maximal recessed position in the recess 38 when the lever-type actuator member 31 is pivoted to the second locked position. On the other hand, the reaction member 36 is able to move under the resilient bias of the spring washer 41 into the maximal extended position in the recess 38 when the lever-type actuator member 31 is pivoted to the first released position. In this way, a spit rod assembly is provided with which the positions of the fork accessories 20 on the spit rod 10 can be quickly and easily adjusted. That is, the locking mechanism 30 provides for a quick, easy and highly reliable fixture and release of the fork accessories 20 without the application of high manual forces by a user. In this embodiment of FIGS. 1 to 3, the spit rod 10 and each of the two fork accessories 20 is preferably predominantly fabricated from stainless steel. It will be appreciated, however, that other robust and durable materials may also be suitable. Some parts of the assembly 100, however, such as the handle 12 may include other, softer materials.

With reference to drawing FIG. 4, a basket accessory 50 designed for a spit rod assembly according to an alternative embodiment of the invention is illustrated. This basket accessory 50 comprises a generally rectangular basket 51 having side walls 52 and end walls 53 formed from sheet or plate metal with air slots or apertures 54 provided therein. The major panels or faces of the rectangular basket 51 are formed as grill panels 55 comprising a framework of rod-like elements. Again in this embodiment, the basket accessory 50 is preferably predominantly fabricated from stainless steel, and may be coated, e.g. powder coated. The upper grill panel 55 seen in FIG. 4 includes knobs 56 provided on the ends of the longitudinally extending stainless steel rod elements. These rod elements are, in turn, adjustably positioned in slots 57 formed in the end walls 53 in order to move the upper grill panel 55 with respect to the side and end walls 52, 53 of the basket 51 to adjust an internal volume of the basket. In each of the end walls 53 of the basket 51, the basket accessory 50 includes a mounting hub 58 for mounting the accessory on a spit rod 10 of a spit rod assembly, in a manner similar to that described above. In this regard, each of the mounting hubs 58 includes a channel 59 which is sized and shaped for receiving the elongate rod 11 of the spit rod 10, such that the basket accessory 50 is movable or slidable along the length of the spit rod 10 via the mounting hubs 58. Furthermore, each of the mounting hubs 58 has a locking mechanism 30 having substantially the same configuration and operation with respect to the spit rod 10 of a spit rod assembly as the locking mechanism 30 described with reference to the embodiment in FIGS. 1 to 3.

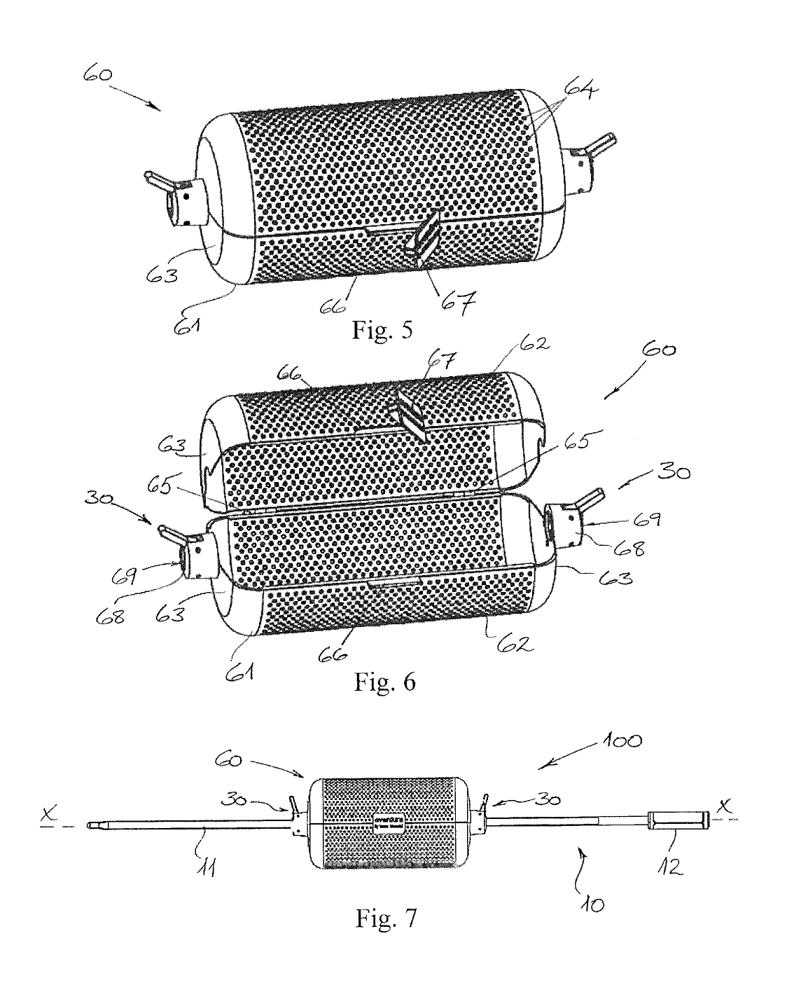

Referring now to FIGS. 5 to 7 of the drawings, a spit rod assembly 100 comprising a spit rod 10 and a basket accessory 60 according to another embodiment is shown in FIG. 7, with the basket accessory 60 itself shown in greater detail in FIGS. 5 and 6. In this embodiment, the spit rod 10 again comprises an elongate rod 11 having a longitudinal axis X and a generally square cross-section transverse to the longitudinal axis. As before, also, the spit rod 10 includes a handle 12 fixed at one end region of the elongate rod 11 for a user to hold and manipulate the spit rod assembly 100 in use. The basket accessory 60 in this example comprises a generally cylindrical basket 61 having two semi-cylindrical side walls 62 and opposite end walls 63 that are formed from sheet metal. Each of the semi-cylindrical side walls 62 are perforated with air-holes or apertures 64 and connected via hinges 65, such that they may pivot between a closed position shown in FIG. 5 and an open position shown in FIG. 6. Each of the semi-cylindrical side walls 62 includes a projecting lip 66 at a front edge thereof, such that the projecting lips 66 abut one another in the closed position. Furthermore, the basket 61 includes a latch member 67 that may pivot to engage the projecting lips 66 and so hold the side walls 62 in the closed position, or to release the projecting lips 66 (as seen in FIG. 5 and FIG. 6) and so allow the side walls 62 to move to the open position. Again in this embodiment, the basket accessory 60 is preferably predominantly fabricated from stainless steel, and may be powder coated.

In each of the end walls 63 of the basket 61, the basket accessory 60 includes a mounting hub 68 for mounting the basket accessory on a spit rod 10 of a spit rod assembly 100, as shown in FIG. 7. In this regard, each of the mounting hubs 68 includes a channel 69 which is sized and shaped for receiving the elongate rod 11 of the spit rod 10, such that the basket accessory 60 is movable along the length of the spit rod 10 via the mounting hubs 68. Furthermore, each of the mounting hubs 68 has a locking mechanism 30 with substantially the same configuration and operation with respect to the spit rod 10 of the spit rod assembly 100 as the locking mechanism described above with reference to the embodiment in FIGS. 1 to 3.

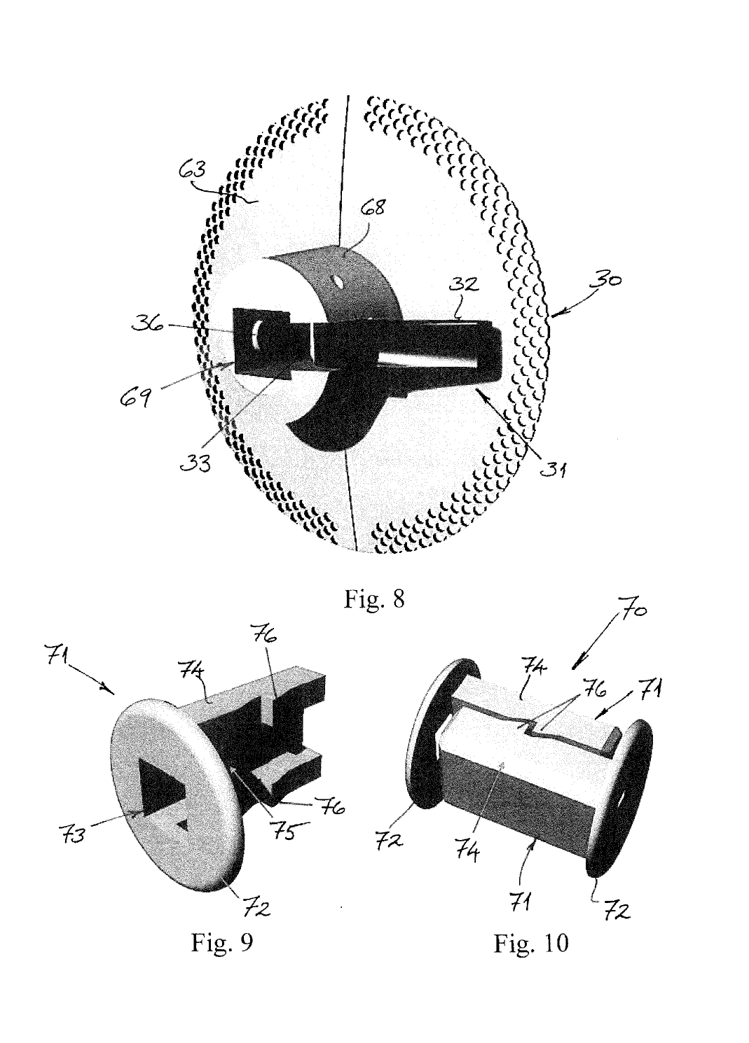

With reference now to drawing FIGS. 8 to 11, an adapter 70 for adapting the channel 69 through the mounting hub 68 of the basket accessory 60 to a different sized spit rod 10 will be described. In this regard, FIG. 8 of the drawings illustrates one end of a basket accessory 60 similar to the embodiment shown in FIGS. 5 to 7. The mounting hub 68 includes a channel 69 having a generally square cross-sectional shape dimensioned for receiving a spit rod 10 with an elongate rod 11 having cross-sectional dimensions of 16 mm×16 mm. As can be seen in FIG. 8, the mounting hub 68 includes a locking mechanism 30. FIGS. 9 and 10 of the drawings show an adapter 70 comprised of two adapter members 71, which operate to reduce the cross-sectional area of the channel through the hub to make it suitable for mounting the accessory on a smaller diameter spit rod 10 with cross-sectional dimensions 8 mm×8 mm. In this regard, each adapter member 71 has an end plate 72 with an opening 73 of cross-sectional shape and dimensions that are designed for or matched to the reduced diameter spit rod 10—in this case, a square cross-section of 8 mm×8 mm. Furthermore, each adapter member 71 has an insert 74 extending from the end plate 72 for insertion into the channel 69 of the hub 68. When two adapter members 71 are arranged or combined as shown in FIG. 10, the inserts 74 preferably cooperate to define a reduced-diameter channel 75 matching the dimensions of the opening 73. As seen in FIG. 10, the adapter members 71 may have an external profile with elements 76 configured for mating or interlocking engagement.

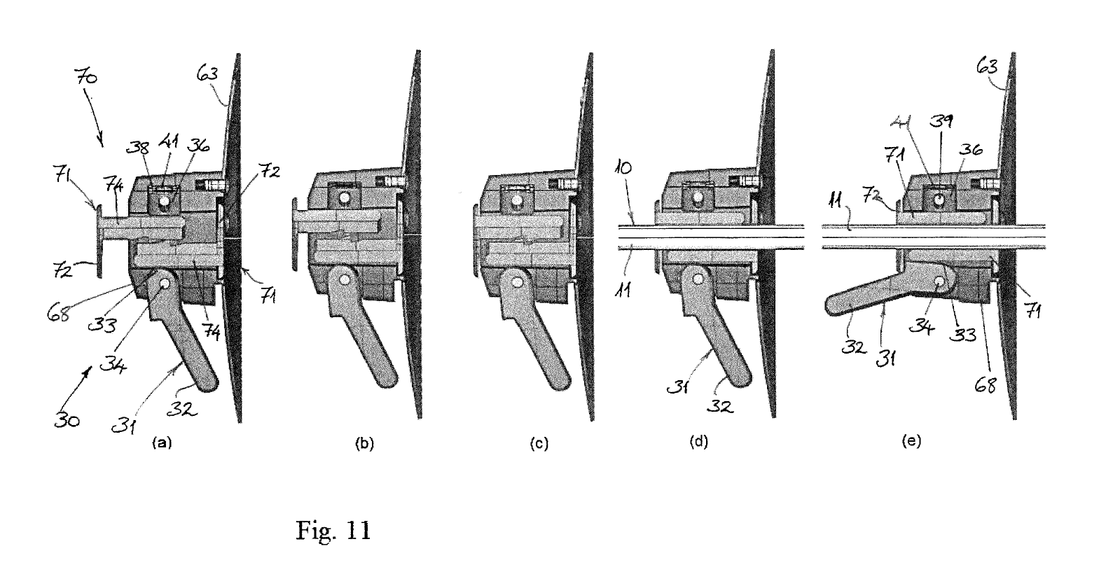

The manner in which these adapter members 71 operate in this adapter 70 is clear from drawing FIGS. 11 (a) to (e). As seen in FIGS. 11(a) to 11(c), one of the adapter members 71 is inserted (via its insert 74) into the channel of the hub 68 at an inner side of the end wall 63 of the basket, and then the other adapter member 71 is inserted (via its insert 74) into the channel of the hub 68 from outside the basket. In order to do this, the actuator member 31 of the locking mechanism 30 should be in the first released position, as this allows the external profile elements of the later inserted adapter member 71 to pass over and engage the profile elements of the first inserted adapter member 71. In this regard, it will be noted that the resiliently biased, movable reaction member 36 is deflected as the second adapter member 71 is inserted into the channel 69 from the outer end of the hub 68. Once both adapter members 71 are in place in the hub 68, the reduced diameter spit rod 10 is inserted through the openings and reduced diameter channel defined by the inserts 74 of the adapter members 71 as shown in FIG. 11(d). Finally, FIG. 11(e) shows the actuator member 31 of the locking mechanism 30 is moved to the second locked position, which applies a clamping force to the adapter members 71, which themselves, in turn, transmit the clamping force to the rod 11 of the spit rod 10. In the locked position, the reaction member 36 is pressed into the recess under the bias of the spring washer 41.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

1. A spit rod assembly for a barbecue, comprising:
an elongate spit rod; and
an accessory configured to be mounted on the spit rod, the accessory comprising at least one mounting hub having a channel for receiving the spit rod therein, such that the accessory is configured to be moved along a length of the spit rod by moving or sliding the accessory relative to the spit rod,
wherein the mounting hub includes a locking mechanism for fixing the accessory at a selected position along the length of the spit rod, and wherein the locking mechanism comprises an actuator member for manual application of a clamping force to the spit rod, and a resiliently biased reaction member located on a side of the spit rod opposite the actuator member for exerting a reaction force or counter-force on the spit rod.

2. The spit rod assembly according to claim 1, wherein the actuator member is configured to be moved between a first released position for movement of the accessory along the spit rod and a second locked position for fixing the accessory relative to the spit rod, and wherein the reaction member is configured to be moved in a direction transverse to a longitudinal extent of the spit rod under the resilient bias.

3. The spit rod assembly according to claim 2, wherein the actuator member comprises a lever configured for pivoting movement between the first released position and the second locked position; wherein the pivoting movement is through an angle in the range of about 30 degrees to about 90 degrees.

4. The spit rod assembly according to claim 3, wherein the actuator member includes a handle portion to be grasped and manually actuated by a user at one end region of the lever, and a nose portion for engaging and applying clamping force to the spit rod at an opposite end region of the lever, wherein the actuator member comprises a pivot pin upon which the lever is pivotally mounted in the hub.

5. The spit rod assembly according to claim 1, wherein the reaction member is accommodated within a recess in the mounting hub for movement under resilient bias in a direction transverse to a longitudinal axis of the spit rod, the recess communicating with the channel for receiving the elongate spit rod.

6. The spit rod assembly according to claim 5, wherein the reaction member is configured to be moved in the direction transverse to the longitudinal axis of the spit rod between a maximal recessed position and a maximal extended position.

7. The spit rod assembly according to claim 5, wherein the reaction member is mounted in the recess via a pin for movement in the direction transverse to the longitudinal axis of the spit rod, wherein the reaction member comprises a slot for receiving the pin, and wherein ends of the slot define limits of movement for the reaction member between the maximal recessed position and the maximal extended position.

8. The spit rod assembly according to claim 5, wherein the reaction member is resiliently biased by at least one spring element, provided in the recess for accommodating the reaction member.

9. The spit rod assembly according to claim 1, wherein the accessory is a basket accessory comprising a basket enclosing a cavity for receiving food items therein, wherein the basket accessory comprises two mounting hubs for mounting the basket on the spit rod, each of the mounting hubs being provided at a respective end of the basket.

10. The spit rod assembly according to claim 1, further comprising an adapter member for adapting the channel through the mounting hub to a spit rod having a smaller diameter.

11. An accessory configured to be mounted on a spit rod, comprising:
at least one mounting hub having a channel for receiving the spit rod there-through, whereby the accessory is configured to be moved along a length of the spit rod by moving or sliding the accessory relative to the spit rod;
wherein the mounting hub includes a locking mechanism for fixing the accessory at a selected position along the length of the spit rod, the locking mechanism comprising an actuator member for manual application of a clamping force to the spit rod, and a resiliently biased reaction member located on a side of the spit rod opposite the actuator member for applying a reaction force or counter-force to the spit rod.

12. A fork accessory for a spit rod assembly, the fork accessory configured to be mounted on a spit rod and comprising:
at least one mounting hub having a channel for receiving the spit rod there-through, whereby the fork accessory is configured to be moved along a length of the spit rod by moving or sliding the fork accessory relative to the spit rod, and
two or more tines or prongs which extend from the mounting hub in a direction generally parallel to the spit rod for fastening a portion of food to the spit rod;
wherein the mounting hub includes a locking mechanism for fixing the fork accessory at a selected position along the length of the spit rod, the locking mechanism comprising an actuator member for manual application of a clamping force to the spit rod, and a movable reaction member, which is resiliently biased and located on a side of the spit rod opposite the actuator member for exerting or applying a reaction force or counter-force to the spit rod.

13. The accessory according to claim 12, wherein the accessory is a basket accessory comprising a basket that encloses a cavity for receiving food items therein, and two mounting hubs for mounting the basket on the spit rod, each of the mounting hubs being provided at a respective end of the basket.

14. The basket accessory for a spit rod assembly, the basket accessory configured to be mounted on a spit rod and comprising:
a basket enclosing a space or cavity for receiving food items therein, and
two mounting hubs for mounting the basket on the spit rod, each of the mounting hubs provided at a respective end of the basket and having a channel for receiving the spit rod there-through, whereby the basket accessory is movable along a length of the spit rod by moving or sliding the basket accessory relative to the spit rod;
wherein each of the mounting hubs includes a locking mechanism for fixing the basket accessory at a selected position along the length of the spit rod, the locking mechanism comprising an actuator member for manual application of a clamping force to the spit rod, and a movable, resiliently biased reaction member located on a side of the spit rod opposite the actuator member for applying a reaction force or counter-force to the spit rod.

15. The accessory according to claim 14, wherein the actuator member of each of the mounting hubs is movable between a first released position for movement of the accessory along the spit rod and a second locked position for fixing the accessory relative to the spit rod, wherein the reaction member is configured to be moved in a direction transverse to a longitudinal extent of the spit rod.

16. The accessory according to claim 15, wherein the actuator member of each of the mounting hubs comprises a lever configured for pivoting movement between the first released position and the second locked position; wherein the pivoting movement is through an angle in the range of about 30 degrees to about 90 degrees.

17. The accessory according to claim 16, wherein the actuator member of each of the mounting hubs has a handle portion to be grasped and manually actuated by a user at one end region of the lever, and a nose portion for engaging and applying clamping force to the spit rod at an opposite end region of the lever, wherein the actuator member of each of the mounting hubs comprises a pivot pin upon which the lever is pivotally mounted in the mounting hub.

18. The accessory according to claim 14, wherein the reaction member of each of the mounting hubs is accommodated within a recess in the mounting hub for movement under resilient bias in a direction transverse to a longitudinal axis of the spit rod.

19. The accessory according to claim 18, wherein the reaction member of each of the mounting hubs is configured to be moved in the direction transverse to the longitudinal axis of the spit rod between a maximal recessed position and a maximal extended position.

20. The accessory according to claim 18, wherein the reaction member of each of the mounting hubs is mounted in the recess via a pin for movement in the direction transverse to the longitudinal axis of the spit rod, wherein the reaction member of each of the mounting hubs comprises a slot for receiving the pin, and wherein ends of the slot define limits of movement for the reaction member.
